(19) United States
(12) Patent Application Publication
(10) Pub. No.: US 2026/0327517 A1
(43) Pub. Date: Oct. 22, 2026

(54) MILD LAUNDRY DETERGENT FORMULATIONS AND METHODS OF MAKING THE SAME

(71) Applicant: HENKEL AG & CO. KGAA, Düsseldorf (DE)

(72) Inventors: Andrew Neal BERNARD, East Lyme, CT (US); Daniel Thomas PIORKOWSKI, Fairfield, CT (US)

(21) Appl. No.: 19/636,923

(22) Filed: Apr. 2, 2026

Related U.S. Application Data
(60) Provisional application No. 63/782,343, filed on Apr. 2, 2025.

(51) Int. Cl. C11D 1/83; C11D 1/14; C11D 1/72; C11D 3/33; C11D 3/37

(52) U.S. Cl. CPC C11D 1/83; C11D 3/33; C11D 3/3753; C11D 1/146; C11D 1/72

(57) ABSTRACT

Detergent formulations having at least one inactive component and an active component incorporated into and/or onto the inactive component are described. The inactive component includes a matrix or substrate material made of a non-active ingredient, and the active component includes an anionic surfactant, a nonionic surfactant, a chelating agent and one or more additives. The ratio of the non-ionic surfactant, the anionic surfactant and the chelating agent may range from about 70:1:0.001 to about 99:23:16.

### CROSS-REFERENCE TO RELATED APPLICATION

This application claims the benefit of U.S. Provisional Application No. 63/782,343, filed Apr. 2, 2025, the entire contents of which are incorporated by reference herein.

### BACKGROUND OF THE INVENTION

Mildness is a significant consumer need and driver for laundry detergent purchase. Henkel's All® Free Clear (AFC) laundry detergent brand is free of dyes and perfumes and utilizes a variety of testing methods as described in US 2018/0016523, the disclosure of which is incorporated by reference into this application. These tests include Zein, Corneosufametry, and Cytokine testing. The aggregate of these scores can be used to determine the mildness of the detergent for the consumer.

In addition to mildness, choiceful ingredient selection is important to the consumer. Safer Choice™ and Leaping Bunny™ are certifications that a consumer may look for when purchasing products.

Laundry detergents are available in various formats for consumers: liquid, unit dose (enclosed in a film made of polyvinyl alcohol for example), powder and sheets.

Consumers may prefer laundry and cleaning products which are easy to handle, sustainable, small and compact. Due to changes in customers' buying behavior, laundry detergents having a reduced package size are becoming more and more preferred. The higher demand for such products is partly due to the increasing importance of home delivery products. Furthermore, simple dosing and cleaning properties similar or even improved compared to those of conventional products are desired. The present invention aims at providing products which can meet one or more of the above-mentioned needs.

Consumers generally prefer mild liquid detergent formulations, and several products that claim to be mild are currently on the market. There is still a need to develop improved mild detergent formulations in the form of sheets that have good cleaning performance.

### SUMMARY OF THE INVENTION

In general, disclosed herein are detergent formulations and methods of making the same. Various non-limiting inventive aspects according to the disclosure are as follows.

In some instances, a first aspect of the disclosure can be described as a detergent formulation comprising at least one inactive component and an active component incorporated into and/or onto the inactive component, wherein the inactive component comprises a matrix or substrate material made of a non-active ingredient, and the active component comprises an anionic surfactant, a nonionic surfactant, a chelating agent, and one or more additives, wherein the ratio of the non-ionic surfactant, the anionic surfactant and the chelating agent ranges from about 70:1:0.001 to about 99:23:16.

In some instances, a second aspect of the disclosure can be described as a detergent formulation according to the first aspect, wherein the inactive component is water dissolvable.

In some instances, a third aspect of the disclosure can be described as a detergent formulation according to the first or second aspect, wherein the detergent formulation is in the form of a sheet.

In some instances, a fourth aspect of the disclosure can be described as a detergent formulation according to the third aspect, wherein the thickness of the sheet ranges from about 0.1 mm to about 20 mm.

In some instances, a fifth aspect of the disclosure can be described as a detergent formulation according to the third or fourth aspect, wherein the sheet has dimensions ranging from about 5×5 cm to about 40×40 cm.

In some instances, a sixth aspect of the disclosure can be described as a detergent formulation according to any one of the first through fifth aspects, wherein the non-active ingredient comprises a polyvinyl, a cellulosic material, a starch, a paraffin, glycerin, propylene glycol, an α-olefin sulfonate, or any combination thereof.

In some instances, a seventh aspect of the disclosure can be described as a detergent formulation according to the sixth aspect, wherein the inactive component is in the form of a sheet.

In some instances, an eighth aspect of the disclosure can be described as a detergent formulation according to any one of the first through seventh aspects, wherein the active component further comprises an aqueous solvent and/or a non-aqueous solvent.

In some instances, a ninth aspect of the disclosure can be described as a detergent formulation according to any one of the first through eighth aspects, wherein the chelating agent comprises tetrasodium iminodisuccinate (IDS), ethylenediamine-N,N′-disuccinic acid (EDDS), methylglycinediacetic acid (MGDA), or any combination thereof.

In some instances, a tenth aspect of the disclosure can be described as a detergent formulation according to the ninth aspect, wherein the chelating agent is methylglycinediacetic acid (MGDA).

In some instances, an eleventh aspect of the disclosure can be described as a detergent formulation according to any one of the first through tenth aspects, wherein detergent formulation is substantially free of water.

In some instances, a twelfth aspect of the disclosure can be described as a detergent formulation according to any one of the first through eleventh aspects, wherein the ratio of the non-ionic surfactant, the anionic surfactant and the chelating agent ranges from about 78:1:0.001 to about 99:15:15.

In some instances, a thirteenth aspect of the disclosure can be described as a detergent formulation according to any one of the first through eleventh aspects, wherein the ratio of the non-ionic surfactant, the anionic surfactant and the chelating agent ranges from about 89:1:0.001 to about 99:8:10.

In some instances, a fourteenth aspect of the disclosure can be described as a detergent formulation according to any one of the first through thirteenth aspects, wherein the one or more additives are selected from the group consisting of acids, bases, amino acids, polymers, defoamers, chlorine scavengers, optical brighteners, fragrances, malodor control agents, enzymes, corrosion inhibitors, and any combination thereof.

In some instances, a fifteenth aspect of the disclosure can be described as a detergent formulation according to any one of the first through fourteenth aspects, wherein the active component and the inactive component are a homogenous mixture.

In some instances, a sixteenth aspect of the disclosure can be described as a detergent formulation according to any one of the first through fifteenth aspects, wherein the detergent formulation comprises from about 1 to about 95 wt % of the inactive component and from about 5 to about 99 wt % of the active component.

In some instances, a seventeenth aspect of the disclosure can be described as a detergent formulation according to any one of the first through fifteenth aspects, wherein the detergent formulation comprises from about 30 to about 60 wt % of the inactive component and from about 40 to about 70 wt % of the active component.

In some instances, an eighteenth aspect of the disclosure can be described as a detergent formulation according to any one of the first through seventeenth aspects, wherein the nonionic surfactant comprises an alcohol alkoxylate and the anionic surfactant comprises an alkyl ether sulfate of salt thereof.

In some instances, an nineteenth aspect of the disclosure can be described as a detergent formulation according to any one of the first through eighteenth aspects, further comprising one or adjunct detergent ingredients.

In some instances, a twentieth aspect of the disclosure can be described as a detergent formulation according to any one of the first through nineteenth aspects, wherein the detergent formulation is water soluble and dissolves within about 0.1 to about 60 seconds after water contact.

In some instances, a twenty-first aspect of the disclosure can be described as a detergent formulation according to any one of the first through twentieth aspects, wherein the detergent formulation has a density ranging from about 20 to about 500 g/m² and/or a weight ranging from about 0.1 to about 90 g.

In some instances, a twenty-second aspect of the disclosure can be described as a detergent formulation according to any one of the first through twenty-first aspects, wherein the active component exhibits a zein score of less than about 1.5%.

In some instances, a twenty-third aspect of the disclosure can be described as a detergent formulation according to any one of the first through twenty-second aspects, wherein the active component exhibits a zein score of less than about 1.0%

### DETAILED DESCRIPTION OF THE INVENTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages, ratios, and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

As used herein, the phrase “substantially free of” means, in the context of a liquid detergent composition that is substantially free of a component, the liquid detergent composition contains 1.0 wt % or less, preferably less than 0.75 wt %, more preferably less than 0.50 wt %, even more preferably less than 0.25 wt %, even more preferably less than 0.10 wt %, even more preferably less than 0.05 wt %, and even more preferably less than 0.01 wt % of said component.

As used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps.

Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

As used herein, the term “textile” means fibers, yarns, woven or unwoven fabrics, cloths and so on. The textiles may be made of natural materials, synthetic materials or blends thereof. Example natural materials include, but are not limited to, cotton, wool, cashmere, mohair, alpaca hair, silk, linen, jute, and cellulosic fibers. Example synthetic materials synthetic materials include, but are not limited to polyester (PES), polyethylene (PE), polypropylene (PP), polyurethane (PU), polystyrene (PS), polyvinyl chloride (PVC), polycarbonate (PC), polyamide (PA), polyphenylene ether, polyphenylene sulfide (PPS), polyoxymethylene (POM), polymethyl methacrylate (PMMA), polyethylene terephthalate (PET), polybutylene terephthalate (PBT), polytetrafluoroethylene (PTFE), polyhydroxyalkanoate (PHA), polyhydroxybutyrate (PHB), polyimide (PI), polylactide (PLA), polyvinylidene fluoride (PVDF), polyetherketone (PEK), and/or copolymers or blends thereof. Blended textiles can be made of at least one natural material and at least one synthetic material. Blended textiles can have a natural material to synthetic material weight:weight ratio ranging from, for example about 5:95 to about 95:5, alternatively from about 10:90 to about 90:10, alternatively from about 15:85 to about 85:15, alternatively from about 20:80 to about 80:20, alternatively from about 25:75 to about 75:25, alternatively from about 30:70 to about 70:30, alternatively from about 35:65 to about 65:35, alternatively from about 40:60 to about 60:40, and alternatively from about 45:55 to about 55:45.

Various aspects of the present disclosure are directed to detergent formulations and methods of making and using the same. Generally, detergent formulations according to various aspects of the disclosure compositionally comprise an active component and an inactive component. The inactive component generally comprises, consists essentially of, or consists of a matrix or substrate material made of a non-active ingredient. The active component generally comprises, consists essentially of, or consists of a detergent composition that provides textile cleaning and/or textile care and optionally compounds useful in the treatment of wash and/or rinse water (or water treatment compounds). In some instances, various aspects of the present disclosure are directed to detergent formulations and methods of making and using the same, where the detergent formulations in in the form of detergent sheets. Detergent sheets are a form of detergent with distinct benefits over existing forms (such as liquids, powders, single unit dose packs, etc.). As discussed further elsewhere herein, components of detergent compositions according to the disclosure may include one or more of surfactants, performance polymers, anti-redeposition polymers, soil release polymers, enzymes, malodor control agents, chelating agents, fragrances, and so on. Also as discussed further elsewhere herein, individual components of active components may include compounds useful in the treatment of wash and/or rinse water including, for example builders, ion chelators, chlorine scavengers and so on. The inactive component generally comprises, consists essentially of, or consists of a matrix or substrate material into and/or onto which the active component is incorporated. As discussed further elsewhere herein, suitable matrix or substrate materials for the inactive component may comprise various materials such as polyvinyl alcohols, starches, fibrous woven and non-woven materials, and non-fibrous woven and non-woven materials as well as secondary components such as stabilization solvents and/or water.

In addition to detergent sheets, detergent formulations according to various aspects of the disclosure are not limited to physical dimensions that approximate a sheet. In some instances, detergent formulations according to various aspects of the disclosure may take the form of other shapes such as cylinders, spheres or spheroids, granules, aggregates, cubes, pyramids, or other polyhedrons, and so on. In some instances, detergent formulations according to various aspects of the disclosure may have a shape selected from a rectangular shape, a square shape, a circular shape, an oval shape, a hexagon shape, a 2-dimensional bear shape (such as a Snuggle bear, a Teddy bear shape), other 2-dimensional cartoon image shapes of a plant or animal, a shape containing from 3 to 10 sides, and combinations thereof. In some instances, detergent formulations according to various aspects of the disclosure, regardless of physical shape, may alternatively be referred to as detergent sheets.

Detergent formulations according to various aspects of the present disclosure are generally non-tacky to provide the user with an appealing tactile feel during use.

Detergent formulations according to various aspects of the present disclosure can comprise varying amount of inactive and active components. In some instances, the amount of inactive component in the detergent formulations can range from about 1 to about 95 wt % and the amount active component in the detergent formulations can range from about 5 to about 99 wt %. In some instances, the amount of inactive component in the detergent formulations can range from about 5 to about 90 wt %, alternatively from about 7.5 to about 85 wt %, alternatively from about 10 to about 80 wt %, alternatively from about 15 to about 75 wt %, alternatively from about 20 to about 70 wt %, alternatively from about 25 to about 65 wt % and alternatively from about 30 to about 60 wt %, and the remaining amount of detergent formulations in each range comprising, consisting essentially of, or consisting of the active component.

Active components of detergent formulations according to the disclosure can have varying compositions. In some instances, active components according to various aspects of the present disclosure may comprise, consist essentially of, or consist of an anionic surfactant, a nonionic surfactant, a chelating agent (also referred to herein as a chelant), and one or more additives. In some instances, active components according to various aspects of the present disclosure may comprise, consist essentially of, or consist of an anionic surfactant, a nonionic surfactant, a chelating agent, a non-aqueous solvent and one or more additives. In some instances, active components according to various aspects of the present disclosure may comprise, consist essentially of, or consist of an anionic surfactant, a nonionic surfactant, a chelating agent, an aqueous solvent (such as water) and one or more additives. In some instances, active components according to various aspects of the present disclosure may comprise, consist essentially of, or consist of an anionic surfactant, a nonionic surfactant, a non-aqueous and/or aqueous solvent (such as water), a chelating agent, and one or more additives. As described elsewhere herein, suitable additives include, but are not limited to acids, bases, amino acids, polymers (such as performance polymers, anti-redeposition polymers, soil release polymers), defoamers, chlorine scavengers, optical brighteners, fragrances, malodor control agents, enzymes, corrosion inhibitors, and any combination thereof. In some instances, active components according to various aspects of the present disclosure may further comprise a cationic surfactant and/or a zwitterionic surfactant.

Various anionic surfactants may be used in active components of detergent formulations according to the disclosure. In some instances, suitable anionic surfactants comprise a hydrophobic tail group (e.g., a linear aliphatic chain) and an anionic hydrophilic head group. The hydrophobic tail group can be a C8-C18 aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). In some instances, the anionic hydrophilic group can be, for example, a sulfate (—OSO₃—), sulfonate (—SO₃—), a phosphate (—OPO₃³—), a carboxylate (—C(O)O—), or the conjugate base of an organic acid. In some instances, polyethylene glycol repeat units designated as “ether” can be disposed between the hydrophobic tail group (e.g., a fatty group) and hydrophilic head group.

In some instances, suitable anionic surfactants include alkyl sulfates, alkyl sulfonates, fatty acid salts, bile acid salts, glutamic acid salts, cholic acid salts, carboxylic poly(ethylene glycol) ethers, taurates, or any combination thereof. In some instances, suitable salts include Group I (e.g., lithium, sodium, potassium, etc.), Group II (e.g., magnesium, calcium, etc.), and ammonium salts.

Examples of suitable alkyl sulfates include, but are not limited to, fatty sulfates (e.g., octylsulfate, decyl sulfate, lauryl (dodecyl) sulfate, myristyl sulfate), dioctyl sodium sulfosuccinate, and alkyl ether sulfates (also known as alcohol ethoxysulfates)). Other examples of fatty sulfates include, but are not limited to, 3-sulfopropyl ethoxylate laurylphenyl ether and coco (coconut fatty acid) sulfate.

Examples of suitable alkyl sulfonates include, but are not limited to, linear alkylbenzene sulfonates (e.g., sodium lauryl benzene sulfonate), perfluoroalkyl sulfonates (e.g., perfluorooctyl sulfonate, perfluorobutyl sulfonate), and methyl ester sulfonate. Other anionic surfactants include bile acid salt, glutamic acid salts (e.g., N-myristoyl-1-glutamic acid), glycolic acid salts, cholic acid salts, carboxylic poly(ethylene glycol) ethers (e.g., glycolic acid ethoxylate laurylphenyl ether, glycolic acid ethoxylate oleyl ether), taurates (e.g., sodium oleic acid methyl taurate, sodium coconut fatty acid methyl taurate, sodium cocoyl methyl taurate), or any combination thereof.

In some instances, suitable anionic surfactants include alkyl ether sulfates (AES). In some instances, suitable AESs have the structure R⁴—O-(EO)ₙSO₃—X⁺, in which R⁴ is a C₈-C₁₈ alkyl group (linear or branched), EO is polyethoxylate, n is typically 1 to 8, and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, or 12 to 16 carbons). In some instances, the cation X⁺ can be a Group I cation, such as sodium cation or potassium cation, particularly sodium cation. In some instances, the AES is sodium laureth sulfate. In some instances, the anionic surfactant is an alkyl ether sulfate with 1 to 5 moles of ethoxylation (n=1-5). In some instances, the alkyl ether sulfate is preferably a lauryl ether sulfate with 1 to 5 moles of ethoxylation (n=1-5), with 3 moles (n=3).

In some instances, the anionic surfactant comprises a linear alkylbenzene sulfonate (LAS). In some instances, the LAS in the detergent composition is of Formula (I).

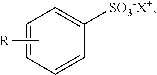

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some instances, the alkyl R and sulfonate are para to one another.

In some instances, active components of detergent formulations according to various aspects of the disclosure are substantially free of linear alkylbenzene sulfonates. In some instances, detergent sheets according to various aspects of the disclosure free of linear alkylbenzene sulfonates.

In some instances, the anionic surfactant comprises an alkyl sulfate (e.g., a lauryl sulfate), a linear alkylbenzene sulfonate, an alkyl ether sulfate, a methyl ester sulfonate, or a combination thereof. In some instances, the anionic surfactant comprises a linear alkylbenzene sulfonate, an alcohol ethoxysulfate, a methyl ester sulfonate, or any combination thereof. In some instances, the anionic surfactant comprises an alkyl ether sulfate (AES).

In some instances, active components of detergent formulations according to various aspects of the disclosure comprise from about 0.1 wt % to about 10 wt % of one or more anionic surfactant relative to the total weight of the active component. In some instances, for example, the total anionic surfactant content can be from about 0.1 wt % to about 9.8 wt %, from about 0.1 wt % to about 9.6 wt %, from about 0.1 wt % to about 9.4 wt %, from about 0.1 wt % to about 9.2 wt %, from about 0.1 wt % to about 9 wt %, from about 0.1 wt % to about 8.8 wt %, from about 0.1 wt % to about 8.6 wt %, from about 0.1 wt % to about 8.4 wt %, from about 0.1 wt % to about 8.2 wt %, from about 0.1 wt % to about 8 wt %, from about 0.1 wt % to about 7.8 wt %, from about 0.1 wt % to about 7.6 wt %, from about 0.1 wt % to about 7.4 wt %, from about 0.1 wt % to about 7.2 wt %, from about 0.1 wt % to about 7 wt %, from about 0.1 wt % to about 6.8 wt %, from about 0.1 wt % to about 6.6 wt %, from about 0.1 wt % to about 6.4 wt %, from about 0.1 wt % to about 6.2 wt %, from about 0.1 wt % to about 6 wt %, from about 0.1 wt % to about 5.8 wt %, from about 0.1 wt % to about 5.6 wt %, from about 0.1 wt % to about 5.4 wt %, from about 0.1 wt % to about 5.2 wt %, from about 0.1 wt % to about 5 wt %, from about 0.1 wt % to about 4.8 wt %, from about 0.1 wt % to about 4.6 wt %, from about 0.1 wt % to about 4.4 wt %, from about 0.1 wt % to about 4.2 wt %, from about 0.1 wt % to about 4 wt %, from about 0.1 wt % to about 3.8 wt %, from about 0.1 wt % to about 3.6 wt %, from about 0.1 wt % to about 3.4 wt %, from about 0.1 wt % to about 3.2 wt %, from about 0.1 wt % to about 3 wt %, from about 0.1 wt % to about 2.8 wt %, from about 0.1 wt % to about 2.6 wt %, from about 0.1 wt % to about 2.4 wt %, from about 0.1 wt % to about 2.2 wt %, from about 0.1 wt % to about 1 wt %, from about 0.1 wt % to about 0.8 wt %, from about 0.1 wt % to about 0.6 wt %, from about 0.1 wt % to about 0.4 wt %, from about 0.1 wt % to about 0.2 wt %, about 0.1 wt %, about 0.5 wt %, about 1 wt %, about 2 wt %, about 3 wt %, about 4 wt %, about 5 wt %, about 6 wt %, about 7 wt %, or about 8 wt % of the total weight of the active component. In some instances, the active component comprises about 0.1 to about 4 wt % of an anionic surfactant. In some instances, the anionic surfactant is an alkyl ether sulfate (AES) is present in an amount of less than 3 wt % of the active component.

In some instances, active components according to various aspects of the disclosure comprise from about 0.1 wt % to about 10 wt % of one or more anionic surfactant relative to the total weight of the detergent formulation. In some instances, for example, the total anionic surfactant content can be from about 0.1 wt % to about 9.8 wt %, from about 0.1 wt % to about 9.6 wt %, from about 0.1 wt % to about 9.4 wt %, from about 0.1 wt % to about 9.2 wt %, from about 0.1 wt % to about 9 wt %, from about 0.1 wt % to about 8.8 wt %, from about 0.1 wt % to about 8.6 wt %, from about 0.1 wt % to about 8.4 wt %, from about 0.1 wt % to about 8.2 wt %, from about 0.1 wt % to about 8 wt %, from about 0.1 wt % to about 7.8 wt %, from about 0.1 wt % to about 7.6 wt %, from about 0.1 wt % to about 7.4 wt %, from about 0.1 wt % to about 7.2 wt %, from about 0.1 wt % to about 7 wt %, from about 0.1 wt % to about 6.8 wt %, from about 0.1 wt % to about 6.6 wt %, from about 0.1 wt % to about 6.4 wt %, from about 0.1 wt % to about 6.2 wt %, from about 0.1 wt % to about 6 wt %, from about 0.1 wt % to about 5.8 wt %, from about 0.1 wt % to about 5.6 wt %, from about 0.1 wt % to about 5.4 wt %, from about 0.1 wt % to about 5.2 wt %, from about 0.1 wt % to about 5 wt %, from about 0.1 wt % to about 4.8 wt %, from about 0.1 wt % to about 4.6 wt %, from about 0.1 wt % to about 4.4 wt %, from about 0.1 wt % to about 4.2 wt %, from about 0.1 wt % to about 4 wt %, from about 0.1 wt % to about 3.8 wt %, from about 0.1 wt % to about 3.6 wt %, from about 0.1 wt % to about 3.4 wt %, from about 0.1 wt % to about 3.2 wt %, from about 0.1 wt % to about 3 wt %, from about 0.1 wt % to about 2.8 wt %, from about 0.1 wt % to about 2.6 wt %, from about 0.1 wt % to about 2.4 wt %, from about 0.1 wt % to about 2.2 wt %, from about 0.1 wt % to about 1 wt %, from about 0.1 wt % to about 0.8 wt %, from about 0.1 wt % to about 0.6 wt %, from about 0.1 wt % to about 0.4 wt %, from about 0.1 wt % to about 0.2 wt %, about 0.1 wt %, about 0.5 wt %, about 1 wt %, about 2 wt %, about 3 wt %, about 4 wt %, about 5 wt %, about 6 wt %, about 7 wt %, or about 8 wt % of the total weight of the detergent formulation. In some instances, the detergent formulation comprises about 0.1 to about 4 wt % of an anionic surfactant. In some instances, the anionic surfactant is an alkyl ether sulfate (AES) is present in an amount of less than 3 wt % of the detergent formulation.

Detergent formulations according to various aspects of the present disclosure comprise one or more nonionic surfactants. In some instances, the nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some instances, the nonionic surfactant is a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or any combination thereof. In some instances, the nonionic surfactant is preferably an alcohol ethoxylate.

Examples of suitable alcohol alkoxylates include, but are not limited to, C₈-C₁₈ ethoxylates and C₈-C₁₈ propoxylates. In some instances, suitable alcohol ethoxylates comprise those of the formula R¹-(EO)ₙ—OH, wherein R¹ is a C₁₀-C₁₈ alkyl group, EO is ethoxylate, and n is an integer of moles from 1 to 15. In some instances, a preferred alcohol ethoxylate has a C₁₂-C₁₅ alkyl group as R¹ with 7 moles of ethoxylation (n=7). In some instances, the alcohol ethoxylate (AE) will have a chemical structure of formula (I):

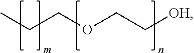

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). In some instances, the alcohol ethoxylate comprises a range of alkyl groups, such as C₁₂-C₁₅ or C₁₂-C₁₄. In some instances, the alcohol ethoxylate comprises contain branches. In some instances, the fatty alcohol ethoxylate comprises 1 to 15 moles (e.g., 1 to 12 moles, 1 to 9 moles, 1 to 7 moles, or about 7 moles) of ethoxylate per mole of alcohol. In some instances, the fatty alcohol ethoxylate can be a C₁₂-C₁₅ fatty alcohol ethoxylate with 1-15 moles of ethoxylate. In some instances, the fatty alcohol ethoxylate comprises a C₁₂-C₁₅ fatty alcohol ethoxylate with 7 moles of ethoxylate. In some instances, the alcohol ethoxylate comprises ethoxylated lauryl alcohol.

Examples of suitable fatty acid alkoxylates include, but are not limited to, those having the formula R¹²—C(O)O-EO-H, in which R¹² is a C₇-C₁₇ alkyl group and EO is polyethoxylate. Similarly, examples of suitable alkyl phenol ethoxylates include those having the formula R¹²-phenyl-O(EO)—H, in which R¹² is a C₈-C₁₈ alkyl group and EO is polyethoxylate.

Examples of suitable alkoxylated amines include, but are not limited to, ethoxylated C₈-C₁₈ alkylamines, tallow amine ethoxylates, lauryl amine ethoxylate ether, 2-2-(2-hydroxyethoxy)ethylaminoethanol, bis(hydroxyethoxyethyl)amine, 2,2′-((2-(2-hydroxyethoxy)ethyl)azanediyl)diethanol, and coco bis(2-hydroxyethyl) amine.

Examples of suitable alkyl glucosides include, but are not limited to, alkyl polyglucosides such as C₈-C₁₈ polyglucosides and especially C₈-C₁₈ polyglucosides having 1 to 3 glucoside units.

Examples of suitable fatty amide alkoxylates, but are not limited to, include those having the formula R¹³—C(O)NH-(EO)—H, in which R¹³ is a C₇-C₁₇ alkyl group and EO is polyethoxylate.

Examples of diesters of alkoxylated fatty acids include, but are not limited to, those having the formula R¹⁴—C(O)O-EO—C(O)—R^{14′}, in which R¹⁴ and R^{14′} are C₇-C₁₇ alkyl groups and EO is polyethoxylate.

Examples of alkoxylated methyl esters of fatty acids include, but are not limited to, those having the formula R¹⁵—C(O)O-EO-R¹⁶, in which R¹⁵ is a C₇-C₁₇ alkyl group, R¹⁶ is a C₁-C₄ alkyl group, and EO is polyethoxylate.

Examples of glycerol fatty esters include, but are not limited to, esters formed from glycerol and fatty acids (for example, C₈-C₁₈ alkyls), such as 2-ethylhexyl oleate, glycerol trioleate, glyceryl monooleate, glyceryl monotallate, n-butyl stearate, neopentylglycol dioleate, pentaerythritol monooleate, pentaerythritol tetraoleate, and trimethylolpropane trioleate.

Examples of suitable castor oil alkoxylates include, but are not limited to, polyethoxylated castor oils.

Examples of suitable ethylene oxide-propylene oxide block copolymers include, but are not limited to, those having the formula R¹⁷O-(EO)ₙ—(PO)ₘ-(EO)ₙ—R¹⁸, in which R¹⁷ and R¹⁸ are the same or different and each is a C₁-C₇ alkyl, a C₅-C₆ cycloalkyl, or an aryl; n is an integer of 30-150 (e.g., about 40-135, about 42-133), and m is an integer of about 10-100 (e.g., about 10-80, about 20-70, about 21-68) and block copolymers such as, PEO-PPO-PEO and PPO-PEO-PPO.

Examples of suitable phenol alkoxylates include, but are not limited to, those having the formula R⁵—C₆H₄-(EO)—H, wherein R⁵ is hydrogen or a C₁-C₁₈ alkyl group, and EO is polyethoxylate, such as octylphenol ethoxylate, nonylphenol ethoxylate, 2-phenoxydecan-1-ol, bisphenol ethoxylate, and a styrenated phenol ethoxylate (e.g., tristyrylphenol ethoxylate). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C11 alkyl, C₁₂ alkyl, C₁₃ alkyl, C₁₄ alkyl, C₁₅ alkyl, C₁₆ alkyl, C₁₇ alkyl, or C₁₈ alkyl). In some instances, the C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C7 alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl).

In some instances, active components according to the disclosure may comprise an alcohol ethoxylate (AE) and an alkyl ether sulfate (AES). In some instances, active components according to the disclosure may comprise an alcohol ethoxylate (AE), an alkyl ether sulfate (AES), but does not comprise (e.g., is substantially free of) a linear alkylbenzene sulfonate. In some instances, active components according to the disclosure may comprise an alcohol ethoxylate (AE). In some instances, active components according to the disclosure may comprise an alkyl ether sulfate (AES). In some instances, active components according to the disclosure may comprise are substantially free of linear alkylbenzene sulfonates.

In some instances, active components according to various aspects of the disclosure comprise from about 1 wt % to about 45 wt % of a nonionic surfactant, based on the total weight of the active component. For example, the total non-ionic surfactant content can be from about 1 wt % to about 40 wt %, from about 1 wt % to about 35 wt %, from about 1 wt % to about 30 wt %, from about 1 wt % to about 25 wt %, from about 1 wt % to about 20 wt %, from about 2 wt % to about 20 wt %, about 3 wt % to about 20 wt %, about 4 wt % to about 20 wt %, about 5 wt % to about 20 wt %, about 6 wt % to about 20 wt %, about 7 wt % to about 20 wt %, about 8 wt % to about 20 wt %, about 9 wt % to about 20 wt %, about 10 wt % to about 20 wt %, about 11 wt % to about 20 wt %, about 12 wt % to about 20 wt %, about 13 wt % to about 20 wt %, about 14 wt % to about 20 wt %, or about 15 wt % to about 20 wt % of the total weight of the active component.

In some instances, active components according to the disclosure may comprise a chelating agent (i.e., a chelant) that serves to improve the cleaning action of the detergent by scavenging metal ions naturally found in water. In some instances, suitable examples of a chelating agent include, but are not limited to, methylglycinediacetic acid (MGDA), citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, ethylenediamine-N,N′-disuccinic acid (EDDS), glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate (IDS)), or any combination thereof. In some instances, the detergent composition comprises tetrasodium iminodisuccinate (IDS), ethylenediamine-N,N′-disuccinic acid (EDDS), methylglycinediacetic acid (MGDA), or any combination thereof. In some instances, the use of MGDA, EDDS, and/or IDS as the chelating agent is preferred.

In some instances, active components according to the disclosure may comprise from about 0 wt % to about 3 wt % of a chelating agent relative to the total weight of the active component or of the total weight of the detergent formulation. For example, the chelating agent can be present in an amount from about 0.001 wt % to about 3 wt %, about 0.001 wt % to about 2.9 wt %, about 0.001 wt % to about 2.8 wt %, about 0.001 wt % to about 2.7 wt %, about 0.001 wt % to about 2.6 wt %, about 0.001 wt % to about 2.5 wt %, about 0.001 wt % to about 2.4 wt %, about 0.001 wt % to about 2.3 wt %, about 0.001 wt % to about 2.2 wt %, about 0.001 wt % to about 2.1 wt %, from about 0.001 wt % to about 2 wt %, about 0.001 wt % to about 1.9 wt %, about 0.001 wt % to about 1.8 wt %, about 0.001 wt % to about 1.7 wt %, about 0.001 wt % to about 1.6 wt %, about 0.001 wt % to about 1.5 wt %, about 0.001 wt % to about 1.4 wt %, about 0.001 wt % to about 1.3 wt %, about 0.001 wt % to about 1.2 wt %, about 0.001 wt % to about 1.1 wt %, about 0.001 wt % to about 1 wt %, about 0.001 wt % to about 0.8 wt %, about 0.001 wt % to about 0.7 wt %, about 0.001 wt % to about 0.6 wt %, about 0.001 wt % to about 0.5 wt %, about 0.001 wt % to about 0.4 wt %, about 0.001 wt % to about 0.3 wt %, about 0.001 wt % to about 0.2 wt %, about 0.001 wt % to about 0.1 wt %, about 0.001 wt % to about 0.09 wt %, about 0.001 wt % to about 0.08 wt %, about 0.001 wt % to about 0.07 wt %, about 0.001 wt % to about 0.06 wt %, about 0.001 wt % to about 0.05 wt %, about 0.001 wt % to about 0.04 wt %, about 0.001 wt % to about 0.03 wt %, or about 0.001 wt % to about 0.02 wt %, or about 0.001 wt % to about 0.01 wt %, based on the total weight of the active component or the total weight of the detergent formulation. In some instances, detergent formulations according to the disclosure are substantially free of chelating agents. In some instances, detergent formulations according to the disclosure are free of chelating agents.

It was discovered that optimizing the weight ratio of surfactants and chelating agents had a significant impact on the detergent composition's mildness while maintaining good stain removal properties. High levels of anionic surfactant, e.g., SLES, were restricted due to dioxane content and high levels of chelant, e.g., MGDA, were restricted due to cost/stability. In some instances, the detergent composition comprises a non-ionic surfactant, anionic surfactant and a chelant in a weight ratio of about 70:1:0.001 to about 99:23:16. In some instances, the non-ionic surfactant, anionic surfactant and a chelant are present in a weight ratio of about 78:1:0.001 to about 99:15:15. In some instances, the non-ionic surfactant, anionic surfactant and a chelant are present in a weight ratio of about 89:1:0.001 to about 99:8:10. In some instances, the non-ionic surfactant, anionic surfactant; and chelant are present in a ratio of about 75:23:2. In some instances, the non-ionic surfactant, anionic surfactant; and chelant are present in a ratio of about 82:17:1. In some instances, the non-ionic surfactant, anionic surfactant; and chelant are present in a ratio of about 91:8:1.

1,4-dioxane is a carcinogenic contaminant that can cause skin irritation. 1,4-dioxane is generated as a byproduct during the manufacture of certain ethoxylated compounds (e.g., alkyl ether sulfates), resulting in detectable quantities of 1,4-dioxane as a trace by-product. In some instances, detergent formulations according to the disclosure comprise about 10 ppm of 1,4-dioxane or less. In some instances, 1,4-dioxane can be present in an amount of about 9 ppm or less, about 8 ppm or less, about 7 ppm or less, about 6 ppm or less, about 5 ppm or less, about 4 ppm or less, about 3 ppm or less, about 2 ppm or less, or about 1 ppm or less of the detergent composition. In some instances, detergent formulations according to the disclosure comprise less than 1 ppm of 1,4-dioxane. In some instances, detergent formulations according to the disclosure are substantially free of 1,4-dioxane. In some instances, detergent formulations according to the disclosure are free of 1,4-dioxane.

In some instances, active components according to the disclosure further comprise one or more additives. Suitable additives include, but are not limited to acids, bases, amino acids, polymers (such as performance polymers, anti-redeposition polymers, soil release polymers, defoamers, chlorine scavengers, optical brighteners, fragrances, malodor control agents, enzymes, corrosion inhibitors, and a combination thereof.

In some instances, active components according to the disclosure may comprise from about 1 wt % to about 20 wt % of a total amount of additives relative to the total weight of the active component or the total weight of the detergent formulation. For example, the total amount of additives can be from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 20 wt %, about 1.5 wt % to about 18 wt %, about 1.5 wt % to about 15 wt %, about 1.5 wt % to about 12 wt %, about 1.5 wt % to about 10 wt %, about 1.5 wt % to about 8 wt %, about 1.5 wt % to about 5 wt %, about 1.5 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, or about 20 wt %, based on to the total weight of the active component or the total weight of the detergent formulation.

To help maintain the pH, in some instances, active components according to the disclosure can further comprise an acid. In some instances, the acid is a compound with a pKₐ of less than about 10. In some instances, the acid is an inorganic acid or an organic acid. Examples of inorganic acids include, but are not limited to, hydrochloric acid, nitric acid, nitrous acid, sulfuric acid, sulfurous acid, phosphoric acid, boric acid, hydrobromic acid, hydroiodic acid, perchloric acid, and combinations thereof. In some instances, the acid is a weak acid such that the acid has a pKₐ of 2 or greater (e.g., a pKₐ ranging from about 2 to about 10). Examples of weak acids include, but are not limited to, organic acids, carbonic acid, hydrocyanic acid, phosphoric acid, sulfurous acid, nitrous acid, or a combination thereof. In some instances, active components according to the disclosure comprise, consist essentially of, or consist of citric acid. In some instances, the acid can be an acid solution (e.g., an acid in water).

In some instances, the acid is an organic acid, which in some instances can additionally act as a chelating agent. In some instances, the organic acid comprises one or more (e.g., 1, 2, or 3) carboxylic acid groups, which can be used singly or in combination. In some instances, for example, monocarboxylic acids include, but are not limited to formic acid, acetic acid, propionic acid, butanoic acid, quinic acid, shikimic acid, lactic acid, sorbic acid, caproic acid, caprylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid. In some instances, the acid is citric acid. In some instances, the acid is ascorbic acid. In some instances, active components according to the disclosure comprise citric acid and ascorbic acid.

In some instances, active components according to the disclosure comprise from about 0.1 wt % to about 10 wt % of acid (e.g., an organic acid, such as citric acid and/or ascorbic acid) relative to the total weight of the active component or the total weight of the detergent formulation. For example, the acid can be present in an amount of about 0.1 wt % to about 5 wt %, about 0.1 wt % to about 3 wt %, about 0.1 wt % to about 2 wt %, about 0.1 wt % to about 1 wt %, about 0.1 wt % to about 0.8 wt %, about 0.1 wt % to about 0.6 wt %, about 0.1 wt % to about 0.4 wt %, about 0.1 wt % to about 0.3 wt %, about 0.2 wt % to about 10 wt %, about 0.2 wt % to about 5 wt %, about 0.2 wt % to about 3 wt %, about 0.2 wt % to about 2 wt %, about 0.2 wt % to about 1 wt %, about 0.2 wt % to about 0.8 wt %, about 0.2 wt % to about 0.6 wt %, about 0.2 wt % to about 0.4 wt %, about 0.2 wt % to about 0.3 wt %, about 0.5 wt % to about 10 wt %, about 0.5 wt % to about 5 wt %, about 0.5 wt % to about 3 wt %, about 0.5 wt % to about 2 wt %, about 0.5 wt % to about 1 wt %, about 0.5 wt % to about 0.8 wt %, about 0.5 wt % to about 0.6 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.15 wt %, about 0.2 wt %, about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt %, based on the total weight of the active component or the total weight of the detergent formulation. In some instances, active components according to the disclosure comprise from about 0.1 wt % to about 1 wt % or about 0.2 wt % to about 0.5 wt % of an organic acid (e.g., citric acid), based on the total weight of the active component or the total weight of the detergent formulation.

In some instances, active components according to the disclosure comprise a base to adjust the pH. In some instances, the base is a compound with a pK_{b} of about 0.1 to about 13. In some instances, the base is monoethanolamine, diethanolamine, triethanolamine, methyl diethanolamine, a hydroxide, a tetraborate, a phosphate, a carbonate, a bicarbonate, or any combination thereof. In some instances, the base comprises a counterion, such as a Group I cation or a Group II cation. In some instances, the base is a Group I hydroxide, a Group II hydroxide, sodium tetraborate, trisodium phosphate, sodium carbonate, or any combination thereof. In some instances, the base is monoethanolamine, sodium carbonate, or a Group I hydroxide (e.g., sodium hydroxide, potassium hydroxide, or any combination of both). In some instances, the base is a base solution (e.g., a base in water). In some instances, active components according to the disclosure comprise a carbonate. In some instances, the base is sodium hydroxide. In some instances, the base is a base solution (e.g., a 50% or 70% sodium hydroxide solution).

In some instances, active components according to the disclosure comprise from about 0.1 wt % to about 15 wt % of base relative to the total weight of the active component or the total weight of the detergent formulation. For example, the base can be present in an amount from about 0.1 wt % to about 12 wt %, about 0.1 wt % to about 10 wt %, about 0.5 wt % to about 15 wt %, about 0.5 wt % to about 12 wt %, about 0.5 wt % to about 10 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 15 wt %, about 1.5 wt % to about 10 wt %, about 1.5 wt % to about 8 wt %, about 1.5 wt % to about 5 wt %, about 1.5 wt % to about 3 wt %, about 2 wt % to about 15 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, or about 15 wt % of the total weight of the active component or the total weight of the detergent formulation. In some instances, active components according to the disclosure comprise from about 0.1 wt % to about 5 wt %, from about 0.1 wt % to about 3 wt %, or from about 0.1 wt % to about 2 wt % of base, based on the total weight of the active component or the total weight of the detergent formulation. In some instances, active components according to the disclosure comprise less than 3 wt % sodium hydroxide (e.g., a 50% NaOH solution). In some instances, active components according to the disclosure comprise from about 1 wt % to about 2 wt % of a carbonate, based on the total weight of the active component or the total weight of the detergent formulation.

In some instances, active components according to the disclosure comprise an acid and a base to form a buffer. In some instances, the buffer is any suitable composition that is water soluble and controls (i.e., maintains) the pH of the detergent composition within a pH of about 5 to about 7.7 (e.g., maintains a pH of about 5, about 5.5, about 6, about 6.5, about 7, about 7.5, or about 7.7). In some embodiments, the pH of the detergent composition is in a range of about 6 to about 7.1 or a pH of about 7. In some instances, the buffer can comprise a weak acid and its conjugate base, a strong acid and a weak base, or a strong base and a weak acid. In some instances, a strong acid will have a pKₐ of less than 2 and a weak acid will have a pKₐ of 2 or greater. In some instances, a strong base will have a pK_{b} of less than 2 and a weak base will have a pK_{b} of 2 or greater. For example, the buffer can comprise sodium hydroxide in combination with a weak acid, such as citric acid.

In some instances, active components according to the disclosure comprise a performance polymer that improves at least one aspect of a washed textile. In some instances, the performance polymer improves the cleaning action of the detergent composition, removes or reduces stains, maintains whiteness, protects color, protects the integrity of a textile, provides odor control, or any combination thereof. In some instances, the performance polymer comprises polyethyleneimine ethoxylate, polyethyleneimine ethoxylate propoxylate, a polycarboxylate (e.g., an acrylic homopolymer or copolymer), carboxymethylcellulose, a polyester, polyvinyl pyrrolidone, a copolymer comprising terephthalic acid, a copolymer comprising maleic acid, a copolymer comprising acrylamino tertiary butyl sulfonate, or any combination thereof. In some instances, the performance polymer comprises an alkoxylated polyethyleneimine, such as polyethyleneimine ethoxylate, polyethyleneimine propoxylate, polyethyleneimine ethoxylate propoxylate, or a combination thereof. In some instances, the detergent composition comprises, in addition to or as alternative to a performance polymer, one or more of a soil release polymer and an anti-redeposition polymer.

In some instances, active components according to the disclosure comprise from about 0.001 wt % to about 5 wt % of a performance polymer relative to the total weight of the active component or the total weight of the detergent formulation. In some instances, the performance polymer can be from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt %, based on the total weight of the active component or the total weight of the detergent formulation. In some instances, active components according to the disclosure comprise from about 0.1 wt % to about 2 wt % of a performance polymer, based on the total weight of the active component or the total weight of the detergent formulation.

In some instances, active components according to the disclosure comprise an anti-redeposition agent that keeps dissolved soil stains stable in the wash water and prevent the stains from redepositing on a textile. In some instances, the anti-redeposition agent is a biodegradable polymer. In some instances, the anti-redeposition agent can be based on acrylic acid, e.g., a homopolymer of acrylic acid, a polycarboxylate based on acrylic acid, a copolymer of acrylic acid and polystyrene, or a copolymer of maleic acid and acrylic acid. In some instances, examples of suitable anti-redeposition agents include, but are not limited to, sodium polyacrylate, modified polyethylene glycol, styrene-acrylic acid copolymer, polyethyleneimine, or a combination thereof. In some instances, the anti-redeposition agent comprises sodium polyacrylate.

In some instances, active components according to the disclosure comprise from about 0.001 wt % to about 5 wt % of an anti-redeposition agent relative to the total weight of the active component or the total weight of the detergent formulation. For example, the anti-redeposition agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt %, based on the total weight of the active component or the total weight of the detergent formulation. In some instances, active components according to the disclosure comprise from about 0.1 wt % to about 5 wt % of an anti-redeposition polymer, based on the total weight of the active component or the total weight of the detergent formulation.

In some instances, active components according to the disclosure comprise a defoamer that helps maintain the rise of foam, which can, in some instances, avoid high foaming or water spilling from a washing machine. In some instances, the defoamer has a low viscosity. In some instances the defoamer comprises coconut fatty acid, a silicone, ethylene-bis-stearamide, a fatty acid, a fatty alcohol, or any combination thereof. In some instances, the defoamer is preferably coconut fatty acid.

In some instances, active components according to the disclosure comprise from about 0.1 wt % to about 10 wt % of a defoamer relative to the total weight of the active component or the total weight of the detergent formulation. For example, the defoamer can be from about 0.1 wt % to about 8 wt %, about 0.1 wt % to about 5 wt %, about 0.1 wt % to about 3 wt %, about 0.5 wt % to about 10 wt %, about 0.5 wt % to about 8 wt %, about 0.5 wt % to about 5 wt %, about 0.5 wt % to about 3 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt %, based on the total weight of the active component or the total weight of the detergent formulation. In some instances, active components according to the disclosure comprise from about 1 wt % to about 5 wt % or about 1 wt % to about 3 wt % of a defoamer relative to the total weight of the active component or the total weight of the detergent formulation. In some instances, active components according to the disclosure comprise about 0.1 wt % to about 0.3 wt % of a defoamer relative to the total weight of the active component or the total weight of the detergent formulation.

In some instances, active components according to the disclosure comprise at least one enzyme to aid in removing stains, including protein stains, oil stains, tannin stains, starch stains, and dyes. For example, a protease is capable of breaking down protein-based stains, such as sweat, blood, mud, and dairy products. Also for example, an amylase is capable of breaking down a starch-based stain, such as cornstarch or potato starch. Also for example, a lipase is capable of breaking down fats. Also for example, a mannanase is capable of breaking down guar and locust bean stains. In some instances, the at least one enzyme is a hydrolytic enzyme. In some instances, the at least one enzyme comprises one a combination of two or more of a protease, an amylase, a mannanase, a lactase, a lipase, a perhydrolase, an oxidoreductase, an endocellulase, an exocellulase. In some instances, active components according to the disclosure comprise a protease, an amylase, a cellulase, a polyesterase, a mannanase, or any combination thereof.

In some instances, active components according to the disclosure comprise a total from about 0.01 wt % to about 5 wt % of at least one enzyme (e.g., a protease, an amylase, a mannanase, or a combination thereof) relative to the total weight of the active component or the total weight of the detergent formulation. For example, the total enzyme content can from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt %, based on the total weight of the active component or the total weight of the detergent formulation. In some instances, active components according to the disclosure comprise a total from about 0.1 wt % to about 5 wt % or about 1 wt % to about 3 wt % of at least one enzyme (e.g., a protease, an amylase, a mannanase, or any combination thereof) relative to the total weight of the active component or the total weight of the detergent formulation.

In some instances, active components according to the disclosure comprise a chlorine scavenger. The chlorine scavenger is any compound that can react with chlorine or a chlorine-generating compound (e.g., hypochlorite) to eliminate or reduce the bleaching activity. In some instances, the chlorine scavenger can also act as a corrosion inhibitor. Examples of a chlorine scavenger include, e.g., an amino acid, iminodisuccinic acid, potassium nitrate, sodium nitrate, iminodisuccinic acid or a salt thereof (e.g., tetrasodium iminodisuccinate), tris (hydroxymethyl) aminomethane, 2-amino-2-methyl-1, 3-propanediol, 2-amino-2-ethyl-1, 3-propanediol, 2-amino-1-butanol, 1-amino-2-propanol, 2-amino-1-propanol, 2-amino-2-methyl-1-propanol, monoethanolamine, diethanolamine, tris(hydroxymethyl)aminomethane, hexamethylenetetramine, and any combination thereof. In some instances, the chlorine scavenger can be monoethanolamine or iminodisuccinic acid.

In some instances, the chlorine scavenger comprises at least one amino acid. In general, the amino acid is a naturally occurring amino acid, including one of the 20 naturally occurring amino acids (e.g., alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, or any combination thereof). In some instances, the amino acid has a charged side chain (e.g., arginine, aspartic acid, glutamic acid, histidine, or lysine). In some instances, the at least one amino acid has a polar uncharged side chain (e.g., serine, threonine, asparagine, or glutamine). In some instances, the at least one amino acid has a hydrophobic side chain (e.g., alanine, valine, isoleucine, leucine, methionine, phenylalanine, tyrosine, or tryptophan). In some instances, the at least one amino acid is lysine. In some instances, the at least one amino acid is cysteine, glycine, or proline. In some instances, the at least one amino acid has a charged side chain or a polar uncharged side chain. In some instances, the at least one amino acid is in the form of a salt, e.g., lysine hydrochloride. In some instances, the at least one amino acid is lysine, threonine, arginine, any salt thereof, or any combination thereof, including salts thereof. In some instances, the at least one amino acid is lysine or a salt thereof (e.g., lysine hydrochloride).

In some instances, active components according to the disclosure comprise from about 0.001 wt % to about 5 wt % of a chlorine scavenger relative to the total weight of the active component or the total weight of the detergent formulation. For example, the chlorine scavenger can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 3 wt %, about 1 wt % to about 2 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt %, based on the total weight of the active component or the total weight of the detergent formulation.

In some instances, active components according to the disclosure comprise an optical brightener (e.g., a fluorescent whitening agent). In some instances, the optical brightener is any suitable hydrophilic compound that absorbs ultraviolet light and emits visible (e.g., blue-violet) light to make textiles appear brighter. The optical brightener can comprise a triazole, a stilbene, or a biphenyl group. Examples of the optical brightener include, e.g., 2,2′-(2,5-thienediyl)bis[5-(2-methyl-2-propanyl)-1,3-benzoxazole, 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 2′,7′-bis(5-(4-(tert-butyl)phenyl)-1,3,4-oxadiazol-2-yl)-N³,N³,N⁶,N⁶-tetraphenyl-9,9′-spirobi[fluorene]-3,6-diamine, N,N-diphenyl-4-(5-(4-(triphenylsilyl)phenyl)-1,3,4-oxadiazol-2-yl)aniline, ((4-((4-(5-(4-nitrophenyl)-1,3,4-oxadiazol-2-yl)phenyl)diazenyl) phenyl)azanediyl)bis(ethane-2,1-diyl) diacetate, ((4-((4-(5-(4-((E)-4-nitrostyryl)phenyl)-1,3,4-oxadiazol-2-yl)phenyl)diazenyl)phenyl)azanediyl)bis(ethane-2,1-diyl) diacetate, 4,4′-diamino-2,2′-stilbenedisulfonic acid, 4,4′-bis(benzoxazolyl)-cis-stilbene, and 2,5-bis(benzoxazol-2-yl)thiophene, and any combination thereof. In some instances, the optical brightener is 2,2′-(2,5-thienediyl)bis[5-(2-methyl-2-propanyl)-1,3-benzoxazole.

In some instances, active components according to the disclosure comprise from about 0.001 wt % to about 5 wt % of an optical brightener relative to the total weight of the active component or the total weight of the detergent formulation. For example, the optical brightener can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt %, based on the total weight of the active component or the total weight of the detergent formulation.

In some instances, active components according to the disclosure comprise a corrosion inhibitor (e.g., an oxygen scavenger), which is any suitable compound that lowers the dissolved oxygen content in the washing medium by reacting with oxygen. In some instances, the corrosion inhibitor can, for example, protect the inside of a washing machine from rusting. Examples of the corrosion inhibitor include, e.g., but are not limited to an inorganic corrosion inhibitor (e.g., a sulfite, a silicate, a polyphosphate, calcium hydroxide), an organic corrosion inhibitor (e.g., calcium hydrogen carbonate, a sulfonate, a phosphonate, a C₁₂-C₁₅ alcohol ether phosphate), or any combination thereof. In some instances, the corrosion inhibitor is preferably sodium sulfite.

In some instances, active components according to the disclosure comprise from about 0.001 wt % to about 5 wt % of a corrosion inhibitor (e.g., an oxygen scavenger) relative to the total weight of the active component or the total weight of the detergent formulation. For example, the corrosion inhibitor can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt %, based on the total weight of the active component or the total weight of the detergent formulation.

In some instances, active components according to the disclosure comprise about 2 to about 35 wt % of a non-ionic surfactant, about 0 to about 8 wt % of an anionic surfactant, and about 0 to about 2 wt % of a chelant, based on the total weight of the active component or the total weight of the detergent formulation, wherein the detergent formulation has a pH of about 3 to about 12 after dissolution, wherein the non-ionic surfactant, anionic surfactant, and chelant are present in a ratio of about 70:0:0 to about 99:23:16, and wherein the detergent composition has a Zein score of not more than about 2%.

In some instances, the non-ionic surfactant, anionic surfactant, and chelant are present in a ratio of about 75:23:2. In some instances, the non-ionic surfactant, anionic surfactant, and chelant are present in a ratio of about 82:17:1. In some instances, the non-ionic surfactant, anionic surfactant, and chelant are present in a ratio of about 91:8:1. In some instances, the non-ionic surfactant is present and the detergent composition does not comprises anionic surfactant or chelant. In some instances, the non-ionic surfactant and chelant are present and the detergent formulation does not comprise anionic surfactant. In some instances, the non-ionic surfactant and anionic surfactant are present, and the detergent formulation does not comprise chelant.

In some instances, active components according to the disclosure comprise an acid, a base, at least one performance polymer, a defoamer, and a chelating agent. In some instances, the detergent composition comprises sodium hydroxide, citric acid, coconut fatty acid and an anti-redeposition polymer and sodium carbonate as additives. In some instances, active components according to the disclosure comprise an acid, a base, at least one enzyme, and a defoamer as additives, and a chelating agent. In some instances, active components according to the disclosure comprise sodium hydroxide, citric acid, coconut fatty acid, MGDA, and at least one enzyme (e.g., protease, amylase, mannanase, or any combination thereof) as additives.

In some instances, active components according to the disclosure comprise, based on the total weight of the active component, water in an amount ranging from about 10 to about 90%, alternatively from about 20 to 85 wt %, and alternatively from about 25 to about 80 wt %, based on the total weight of the active component or the total weight of the detergent formulation.

In some instances, active components according to the disclosure comprise, based on the total weight of the active component or the total weight of the detergent formulation, water, about 10 to about 25 wt % of a non-ionic surfactant, about 0.1 to about 8 wt % of an anionic surfactant, and about 0 to about 2 wt % of a chelant, wherein the detergent formulation has a pH of about 6 to about 12, wherein the non-ionic surfactant, anionic surfactant, and chelant are present in a ratio of about 70:1:0 to about 99:23:16, and wherein the detergent formulation has a Zein score of not more than about 2%.

In some instances, active components according to the disclosure comprise, based on the total weight of the active component or the total weight of the detergent formulation, water, about 10 to about 25 wt % of a non-ionic surfactant, about 0.1 to about 8 wt % of an anionic surfactant, and about 0 to 2 wt % of a chelant, wherein the detergent formulation has a pH of about 6 to about 12, wherein the non-ionic surfactant, anionic surfactant, and chelant are present in a ratio of about 70:1:001 to 99:23:16, and wherein the detergent formulation has a Zein score of not more than about 2%.

In some instances, active components according to the disclosure comprise, based on the total weight of the active component or the total weight of the detergent formulation, water, about 10 to about 25 wt % of a non-ionic surfactant, about 0.1 to about 8 wt % of an anionic surfactant, and about 0 to about 2 wt % of a chelant, wherein the detergent formulation has a pH of about 6 to about 12, wherein the non-ionic surfactant, anionic surfactant, and chelant are present in a ratio of about 78:1:0.001 to about 99:15:15, and wherein the detergent formulation has a Zein score of not more than about 2%.

In some instances, active components according to the disclosure comprise, based on the total weight of the active component or the total weight of the detergent formulation, water, about 10 to about 25 wt % of a non-ionic surfactant, about 0.1 to about 8 wt % of an anionic surfactant, and about 0 to about 2 wt % of a chelant, wherein the detergent formulation has a pH of about 6 to about 12, wherein the non-ionic surfactant, anionic surfactant, and chelant are present in a ratio of about 89:1:0.001 to about 99:8:10, and wherein the detergent formulation has a Zein score of not more than about 2%.

In some instances, active components according to the disclosure comprise, based on the total weight of the active component or the total weight of the detergent formulation, water, about 12 to about 17 wt % of an alcohol ethoxylate (AE), about 0.1 to about 4 wt % of an alkyl ether sulfate (AES), about 0.1 to about 0.4 wt % of MGDA, and about 0.1 to about 0.2 wt % preservative.

In some instances, active components according to the disclosure comprise, based on the total weight of the active component or the total weight of the detergent formulation, water, about 13 wt % of an alcohol ethoxylate (AE), about 4 wt % of an alkyl ether sulfate (AES), and about 0.3 wt % of MGDA, wherein the composition has a pH of about 6 to about 12 and wherein the detergent composition has a Zein score of not more than about 2%.

In some instances, active components according to the disclosure comprise, based on the total weight of the active component or the total weight of the detergent formulation, water, about 14 wt % of an alcohol ethoxylate (AE), about 3 wt % of an alkyl ether sulfate (AES), and about 0.2 wt % of MGDA, wherein the composition has a pH of about 6 to about 12, and wherein the detergent composition has a Zein score of not more than about 2%.

In some instances, active components according to the disclosure comprise, based on the total weight of the active component or the total weight of the detergent formulation, water, about 17 wt % of an alcohol ethoxylate (AE), about 1.4 wt % of an alkyl ether sulfate (AES), and about 0.1 wt % of MGDA, wherein the composition has a pH of about 6 to about 12, and wherein the detergent composition has a Zein score of not more than about 2%.

In some instances, active components according to the disclosure may further comprise adjunct detergent ingredients. Suitable adjunct detergent ingredients, include but are not limited to: bleaches, in particular a source of peroxygen such as percarbonate salts and/or perborate salts, preferred is sodium percarbonate; bleach activators such as tetraacetyl ethylene diamine, oxybenzene sulphonate bleach activators, such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; polymeric carboxylates, preferably copolymers of maleic acid and acrylic acid and salts thereof, suds suppressing systems such as silicone based suds suppressors; fluorescent whitening agents; photobleaches; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines; anti-redeposition components such as carboxymethyl cellulose and polyesters; sulphamic acid or salts thereof, citric acid or salts thereof as well as other organic builders; inorganic builders, including carbonate salts, such as sodium carbonate, sodium bicarbonate and mixtures thereof, aluminosilicate builders, such as zeolites, in particular zeolite A, zeolite X, zeolite P and zeolite MAP, silicate salts, preferably sodium silicate; dyes such as orange dye, blue dye, green dye, purple dye, pink dye, or any mixture thereof, and further complexing agents, such as phosphonates, including those based on hydroxyl alkanes, amino alkanes or amino acids, such as 1-hydroxyethane-1, 1-diphosphonate (HEDP), ethylenediamine tetramethylene phosphonate (EDTMP), diethylenetriaminepentamethylene phosphonate (DTPMP), and lysine tetramethylene phosphonate (LTMP); sodium sulfate; enzyme stabilizers, including protease inhibitors; mineral oil; organic solvents, including monoalcohols, glycerol and propylene glycol; antibacterial and antimicrobial substances; antioxidants; preservatives; bittering agents, and water.

In some instances, active components according to the disclosure comprise, based on the total weight of the active component or the total weight of the detergent formulation, adjunct ingredients in an amount ranging from about 0.01 to about 50 wt. %, preferably in amounts of from about 0.01 to about 20 wt. %, more preferably in amounts of from about 0.01 to about 15 wt. %, more preferably in amounts of from 0.1 to 10 wt. %, most preferably in amounts of from about 0.1 to about 5 wt.

In some instances, the adjunct detergent ingredients are preferably selected from glycerol, propylene glycol, phosphonate, citric acid, other complexing agents, mineral oil, enzyme stabilizers, preservatives, water, and combinations thereof, more preferably, from mineral oil, organic solvents, preservatives, and water.

In some instances, the detergent formulations according to the disclosure further comprise mineral oil in an amount ranging from about 0.01 to about 20 wt %, preferably from about 0.1 to about 5 wt % by weight, relative to the total weight of the detergent formulation.

In some instances, detergent formulations according to the disclosure comprise preservatives in an amount of from about 0.001 to about 10 wt %, preferably in amounts of from about 0.1 to about 5 wt %, based on the total weight of the detergent formulation.

In some instances, detergent formulations according to the disclosure comprise a solvent content, with the exception of water, in an amount from about 0.01 to about 15% by weight, preferably from about 0.3 to about 10% by weight, relative to the total weight of the detergent formulation. In some instances, detergent formulations according to various aspects of the present disclosure are substantially free of solvent(s). In some instances, detergent formulations according to various aspects of the present disclosure are free of solvent(s).

Solvents with the exception of water include nonaqueous solvents. Suitable nonaqueous solvents include, but are not limited to propylene glycol, glycerin, ethanol, dipropylene glycol, a polyethylene glycol, a glycol ether, or any combination thereof. In some instances, the nonaqueous solvent is glycerol (glycerin), ethylene glycol, ethanol, or a 4C+ compounds. The term “4C+ compound” refers to one or more of: polyethylene glycol esters such as polyethylene glycol stearate, propylene glycol laurate, and/or propylene glycol palmitate; ethyl ester ethoxylate; diethylene glycol; dipropylene glycol; tetramethylene glycol; butylene glycol; pentanediol; hexylene glycol; heptylene glycol; octylene glycol; 2-methyl-1,3-propanediol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with a number average molecular weight of about 3,500 Daltons or less; and ethoxylated fatty acids. In some instances, the non-aqueous co-solvent is or includes a relatively low molecular weight polyethylene glycol (PEG). In some instances, the polyethylene glycol has a molecular weight ranging from about 200 to about 1000 g/mol (or Daltons), alternatively a molecular weight ranging from about 200 to about 800 g/mol, or alternatively a molecular weight of about 400 g/mol. In some instances, the polyethylene glycol has a weight average molecular weight of less than about 600 Da, e.g. about 400, such as those having a weight average molecular weight of from about 380 to about 420 Da. In other instances, PEG 200, PEG 250, PEG 300, PEG 350, PEG 400, PEG 450, PEG 500, PEG 550, and/or PEG 600 (wherein the numerals represent the approximate weight average molecular weight in Daltons or grams/mol) may be used.

In some instances, detergent formulations according to the disclosure comprise up to about 20 wt % of water, up to about 10 wt % of water, more preferably up to about 5 wt % of water, based on the total weight of the detergent formulation.

In some instances, detergent formulations according to the disclosure are phosphate-free, i.e., comprise less than about 1 wt % phosphate builder and preferably are free from phosphate builders. The term “phosphate-free”, as used herein, does not relate to phosphonates.

The inactive component of detergent formulations according to the disclosure comprise at least one non-active ingredient. In some instances, the at least one non-active ingredient is present in the detergent formulation in an amount ranging from about 10 to about 90 wt %, alternatively about 10 to about 70 wt %, alternatively about 20 to about 70 wt %, and alternatively about 20 to about 65 wt %, based on the total weight of the detergent formulation. Various inactive components and non-active ingredients may be used in detergent formulations according to the disclosure. Inactive components and non-active ingredients used in detergent formulations according to the disclosure are preferably water soluble and/or water dissolvable.

In some instances, the non-active ingredient is a polyvinyl, such as for example, a polyvinyl alcohol, a polyvinyl acetate, a polyvinyl pyrrolidone, or any other suitable polyvinyl polymer. In some instances, the polyvinyl is a polyvinyl alcohol (PVOH). In some instances, the polyvinyl alcohol is present in detergent formulations according to the disclosure in an amount ranging from about 10 to about 50 wt %, alternatively about 10 to about 40 wt %, alternatively about 10 to about 25 wt %, and alternatively about 10 to about 20 wt %, based on the total weight of the detergent formulation.

In some instances, the non-active ingredient is a cellulosic material. In some instances, the cellulosic material is cellulose. In some instances, the cellulosic material is present in the sheet composition in an amount ranging from about 10 to about 50 wt %, alternatively about 10 to about 40 wt %, alternatively about 10 to about 25 wt %, and alternatively about 10 to about 20 wt %, based on the total weight of the detergent formulation.

In some instances, the non-active ingredient is a starch. Examples of starch include, but are not limited to, corn starch, rice starch, tapioca starch, pea starch, and potato starch. In some instances that starch is a chemically modified starch. In some instances, the chemically modified starch is an oxidized starch. In some instances, the chemically modified starch is a reduced starch. In some instances, the starch is present in the detergent formulation in an amount ranging from about 5 to about 60 wt %, alternatively about 10 to about 50 wt %, alternatively about 20 to about 40 wt %, and alternatively about 20 to about 35 wt %, based on the total weight of the detergent formulation.

In some instances, the non-active ingredient is a paraffin. In some instances, the paraffin is liquid paraffin. In some instances, the liquid paraffin is mineral oil. In some instances, the paraffin is present in the detergent formulation in an amount ranging from about 0.01 to about 5 wt %, alternatively about 0.01 to about 5 wt %, and alternatively about 1 to about 5 wt %, based on the total weight of the detergent formulation.

In some instances, the non-active ingredient is a non-aqueous solvent. In some instances, the non-aqueous solvent is glycerin. In some instances, the non-aqueous solvent is propylene glycol. In some instances, the non-aqueous solvent is present in the detergent formulation in an amount ranging from about 5 to about 25 wt %, alternatively about 10 to about 25 wt %, and alternatively about 10 to about 20 wt %, based on the total weight of the detergent formulation.

In some instances, the non-active ingredient is an α-olefin sulfonate. In some instances, the α-olefin sulfonate is present in the detergent formulation in an amount ranging from about 5 to about 40 wt %, alternatively about 10 to about 40 wt %, alternatively about 20 to about 40 wt %, and alternatively about 15 to about 35 wt %, based on the total weight of the detergent formulation.

Detergent formulations according to various aspects of the present disclosure can be prepared in various ways. Exemplary preparation techniques may be as follows.

In some instances, the active and inactive component can be mixed together to form a homogenous admixture. Once mixed together, the components produce a liquid or otherwise free flowing mixture that can poured on a drying plate or mold of predetermined dimensions. Excess water and/or solvent can be evaporated from the mixture, resulting in a semi-solid or solid, and/or flexible, formulation. This formulation can then be cut into individual units for end use. In some instances, such a method may further comprise compressing or rolling the semi-solid or solid formulation.

In some instances, the active component may be incorporated into or onto a pre-made woven or nonwoven inactive component via an impregnation process. An exemplary impregnation process includes submerging or soaking an inactive component in the active component for a period of time sufficient to allow the active component to incorporate into and/or onto the inactive component. Another exemplary impregnation process includes spraying, dripping or coating an inactive component on a surface of an inactive component in an amount and for a period of time sufficient to incorporate into and/or onto the inactive component

In some instances, the active component may be incorporated into or onto an inactive component by forming a layered construction comprising two layers of inactive component with a layer of active component sandwiched therebetween.

Detergent formulations according to various aspects of the present disclosure, when in the form of a sheet, can be manufactured that are desired for ease of handling, dosage and solubility in use. In some instances, the thickness of the sheets ranges from about 0.1 mm to about 20 mm, preferably from about 0.25 mm to about 1.5 mm, and more preferably from about 0.7 to about 0.9 mm. Thicker sheets may not completely dissolve in a common washing cycle. Thinner sheets might not be robust enough and show cracks after storage which is undesirable due to reduced consumer acceptance. In some instances, the sheets may be fabricated as about 5 cm×5 cm sheets, alternatively about 12 cm×12 cm sheets, alternatively about 25 cm×25 cm sheets, and alternatively about 40 cm×40 cm sheets. It will, however, be appreciated that any other suitable dimensions may be fabricated.

Detergent formulations according to various aspects of the present disclosure, when in the form of sheets, may be fabricated to have a density of about 20 to 500 g/m², alternatively about 40 to about 80 g/m², about 55 to about 75 g/m², or about 60 to about 75 g/m². The density can be determined according to ISO 9073-1 (of the year 1989). In some instances, a single sheet of a detergent formulation according to the disclosure can have a total weight of from about 0.1 to about 90 g, more preferably of from about 1 to about 10 g.

In some instances, detergent formulations according to various aspects of the present disclosure are water-soluble. “Water-soluble”, as used in the disclosure, means that the formulation when placed into 2 liters of 20° C. deionized water is dissolved to an extent of at least 80 wt %, preferably to at least 90 wt % more preferably completely, i.e. 100%, after 2 minutes, preferably 1 minute, more preferably 30 seconds. Completely dissolved, as used in this context, means that no residual solids remain visible with the naked eye.

In some instances, detergent formulations according to various aspects of the present disclosure dissolve within 0.1 seconds to 60 minutes when the formulation is in contact with water, preferably within a normal washing cycle of an automatic washing machine.

In some instances, the detergent formulation is non-woven. In some instances, the detergent formulation is woven. According to various aspects of the present disclosure, the inactive component is in the form of a matrix. In some instances, the matrix is a non-woven matrix. In some instances, the matrix is a woven matrix. In some instances, the detergent formulation is a homogenous admixture of the active component and the inactive component. In some instances, the detergent formulation is preferably a homogenous admixture of the active component and the inactive component.

In some instances, detergent formulations according to various aspects of the present disclosure comprise up to 20 wt.-% of water, more preferably up to 5 wt.-% water, based on the total weight of the detergent formulation. In some instances, detergent formulations according to various aspects of the present disclosure are substantially free of water. In some instances, detergent formulations according to various aspects of the present disclosure are free of water. In some instances, detergent formulations according to various aspects of the present disclosure are substantially free of free or residual water, while containing variable amounts of bound water. In some instances, detergent formulations according to various aspects of the present disclosure are free of free or residual water, while containing variable amounts of bound water. Residual water is not available as bulk moisture, does not behave as liquid water, and does not affect the dryness or shelf-stability of a detergent formulation as described herein. Generally, detergent formulations according to various aspects of the present disclosure having a water activity of less than 0.5, and alternatively less than 0.4, may be preferred.

Regardless of the shape that the water-soluble detergent formulation may have, it can include at least one symbol or message on at least one of the surfaces of said sheet, wherein said symbol or message can be printed or stamped. Detergent formulations according to various aspects of the present disclosure are generally non-tacky to provide the user with an appealing tactile feel during use.

After manufacturing, the detergent formulation can be packaged into suitable packaging, which may be a paper or plastic package, preferably a plastic package. More preferably the package does not allow water to enter the package. Also suitable are polymeric water-soluble films.

Also provided herein are methods of cleaning laundry. Methods of cleaning laundry may include combining a sheet of the sheet composition according to various instances of the disclosure with an amount of water to form a diluted detergent composition having from about 0.1 grams to about 1 gram of the detergent composition per liter of water and cleaning the laundry using the diluted detergent composition. In some instances the diluted detergent composition has a concentration of about 0.01 to about 10 grams, alternatively from about 0.02 to about 8 grams, alternatively from about 0.03 to about 6 grams, alternatively from about 0.04 to about 6 grams, alternatively from about 0.05 to about 5 grams, alternatively from about 0.06 to about 4 grams, alternatively from about 0.07 to about 3 grams, alternatively from about 0.08 to about 2 grams, and alternatively from about 0.09 to about 1.5 grams of the detergent composition per liter of water.

Mildness is a significant consumer need and driver for laundry detergent purchase. There are several methods to measure the skin irritancy potential of a surfactant composition, such as the testing methods as described in US 2018/0016523, the entire disclosure of which is incorporated herein by reference. These tests include Zein, Corneosufametry, and Cytokine testing. The aggregate of these scores can be used to determine the mildness of a detergent for consumers.

One method to test the skin irritancy potential of a surfactant composition is the Zein test. A Zein score is measured using a Zein test (Gott, E., Aesthet. Medzin. Tenside, 15:313 (1966)). The Zein test determines the extent of denaturation of Zein corn protein after exposure to a surfactant for a given period of time. Generally, the higher the Zein score, the greater the skin irritation potential.

Another method to measure the skin irritancy potential is corneosurfametry (CSM) test, a noninvasive quantitative test that measures the interaction between surfactants and human stratum corneum (Pierard et al., Dermatology 189:152-156 (1994)). Corneosurfametry involves removing a few layers of skin using cyanoacrylate skin surface strippings, short contact time with surfactants followed by staining the samples with fuchsia dyes. A less damaged barrier allows greater penetration of the stain, therefore giving a more intense color, which is measured using colorimetrically with L*a*b*color space. This method is predictive of both protein and lipid damage in the skin. CIM (Color Indicator of Mildness) values are obtained from a corneosurfametry test. In a comparative study, the higher the CIM value, the milder the surfactant formulation.

A third method to evaluate the irritation effect of a surfactant formulation is measured by cytokine release of representative human skin model in response to the surfactant formulation. Where skin tissue viability is not decreased by 50% as compared to the negative control tissue (as measured by MTT reduction), the inflammatory potential is then measured by the production of the cytokines IL-1a. and/or IL-1ra. MTT is a dye used to stain the skin cells called 3-(4, 5-dimethylthiazol-2-yl)-2, 5-diphenyltetrazolium bromide. In a comparative study, a lower cytokine release value means a milder surfactant formulation.

Described in U.S. Pat. No. 10,066,190, the entire contents of which are incorporated by reference herein, are methods for determining how mild an aqueous laundry detergent formulation is for a user. The method comprises the steps of: (i) providing a solution comprising a laundry cleaning effective amount of a surfactant composition, (ii) subjecting an appropriate dilution of the solution to Zein test, corneosurfametry test, and in vitro cytokine release test for IL-1a and IL-1ra response, respectively, to obtain a Zein score, a corneosurfametric (CSM) value, and a cytokine release value, and (iii) deriving at composite mildness indicator (CMI) for each solution based the Zein score, the CSM value, and the cytokine release value.

The composite mildness indicator (CMI) may also be called detergent mildness indicator (DMI). Specifically, the CMI can be derived from (1) the Zein score, CSM value, and cytokine release value IL-1a of the formulation; (2) the Zein score, CSM value, and cytokine release value (IL-1a+IL-1ra) of the formulation; (3) the Zein score, CSM value, and cytokine release value (IL-1ra/IL-1a) of the formulation; (4) the Zein score, CSM value, and cytokine release value log 10 (IL-1ra/IL-1a) of the formulation; or (5) the Zein score, CSM value, and cytokine release measurement (IL-1a/IL-1ra) of the formulation.

It was discovered that a mild composition (i.e., a composition with a low Zein score) could be provided with a detergent formulation comprising mild surfactants. In some instances, mildness of detergent formulations according to the disclosure is controlled by the use of surfactants and chelating agents in varying ratios to improve mildness while maintaining stain removal performance.

As used herein the phrase “Zein score” refers the measurement obtained from the Zein test as described herein. It can also be referred to as “Zein solubilized %.” In some instances, detergent compositions (active component) described herein have a Zein score of less than about 3% when tested as a 10% dilution. In certain instances, detergent formulations described herein have a Zein score of from about 0.01% to about 3%, alternatively from about 0.01% to about 2.75%, alternatively from about 0.01% to about 2.5%, alternatively from about 0.01% to about 2.25%, alternatively from about 0.01% to about 2%, alternatively from about 0.01% to about 1.75%, alternatively from about 0.01% to about 1.5%, alternatively from about 0.01% to about 1.25%, and alternatively from about 0.01% to about 1% when tested as a 10% dilution. In other instances, detergent compositions (active component) described herein can have a Zein score of less than about 2.75%, preferably less than about 2.5%, more preferably less than about 2.25%, even more preferably less than about 2%, even more preferably less than 1.75%, even more preferably less than about 1.5%, even more preferably less than about 1.25%, and even more preferably less than about 1% when tested as a 10% dilution.

In some instances, detergent compositions (active component) according to various aspects of the disclosure have a Zein score less than about 0.75%. In some instances, detergent compositions (active component) according to various aspects of the disclosure have a Zein score less than about 0.6%. In some instances, detergent compositions (active component) according to various aspects of the disclosure have a Zein score less than about 0.5%. In some instances, detergent compositions (active component) according to various aspects of the disclosure have a Zein score less than about 0.4%. In some instances, detergent compositions (active component) according to various aspects of the disclosure have a Zein score ranging from about 0.3 to about 0.5%.

As described elsewhere herein, detergent formulations may generally comprise an inactive component and an active component. As may be appreciated by one of ordinary skill in the art, detergent formulations of the disclosure may exhibit zein scores lower than that of an active component in bulk, liquid form due to the amount of active component contained within a detergent formulation due to a lower amount and/or lowered dilution percentage of the active component in such a detergent formulation compared to the use of the bulk, liquid active component.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

Exemplary detergent compositions (active component Formulations A-I) were prepared with the components listed in Tables 1 and 2. The ratios as described in Table 2 fill the 17.28% hole in the base formulation of Table 1. All exemplary detergent compositions (active components) were adjusted to a pH of 10.6 to 11.4. Formulation J was prepared as a comparative formulation based on a commercially available mild detergent composition.

The examples in Examples 1, 2 and 3 were tested as a liquid as they are relevant to only the active component of a detergent formulation as described herein, with a significant amount of water being removed during the sheet making process, to make the total amount of water in the sheet less than 20%, less than 15%, less than 10%, less than 5% of the entire composition. Carbonate can be replaced with a different buffer such as citrate, maleate, and lysine depending on the target pH of the active composition of the sheet. Preservative can also include BIT, MIT, CIT, sorbate, benzoate, or other commercially available preservatives, depending on intended pH. Polymer can be a performance polymer, anti-redeposition polymer, soil release polymer, dye transfer inhibitor polymer, and other polymers commonly known to the art.

TABLE 1
Base formulation

| Material | % |
|---|---|
| Water | QS to 100 |
| Carbonate | 1.25 |
| Polymer | 0.5 |
| Defoamer | 0.23 |
| Preservative | 0.15 |
| Hole | 17.28 |

TABLE 2

| | Alcohol | | |
|---|---|---|---|
| | Ethoxylate | | |
| Formula | (wt %) | SLES (wt %) | MGDA (wt %) |
| A | 7 | 80 | 13 |
| B | 20 | 80 | 0 |
| C | 76.75 | 20 | 3.25 |
| D | 70.25 | 20 | 9.75 |
| E | 30.25 | 60 | 9.75 |
| F | 87 | 0 | 13 |
| G | 53.5 | 40 | 6.5 |
| H | 100 | 0 | 0 |
| I | 36.75 | 60 | 3.25 |
| J | 65.13 | 32.56 | 2.31 |
| (Comparative) | | | |

SLES: sodium lauryl ether sulfate
MGDA: methylglycinediacetic acid

### Example 2

A design of experiments with the following material ratios was evaluated for stain performance, Zein and viscosity.

For stain win/loss performance, Formulations A-I were tested against a different comparative detergent from the market (not listed in the table above). A total of 12 stains were tested on both knitted cotton and polyester fabric at 15° C. and 32° C., registering 24 comparative points per temperature. Products were dosed at approximately 45 mL dose per wash.

The stain performance comparison test results are shown below in Table 3. The Zein (mildness) scores of each formulation are shown below in Table 4. The analysis of variance (ANOVA) of the Zein and win/loss performance vs. Formulation J was significant at 15° C. wash temperatures. Viscosity and win/loss performance at 32° C. were not significant.

TABLE 3
Stain Performance

| | | Win/Loss | Win/Loss | Win/Loss |
|---|---|---|---|---|
| | | 15 °C | 15 °C | 15 °C |
| Formula | pH | Run 1 | Run 2 | Average |
| A | 10.89 | −2 | DNT | DNT |
| | | | (did not test) | |
| B | 10.65 | −8 | −5 | −8 |
| C | 10.63 | −1 | −6 | −11 |
| D | 10.72 | 2 | −3 | −4 |
| E | 10.87 | 1 | −2 | −5 |
| F | 10.77 | 2 | −2 | −1 |
| G | 10.73 | 1 | DNT | DNT |
| H | 10.62 | −5 | −8 | −9 |
| I | 10.65 | 0 | DNT | DNT |
| J | 10.63 | −7 | −11 | −9 |
| (comparative) | | | | |

TABLE 4
Zein Scores

| | | Specific | | Zein | Zein | Zein |
|---|---|---|---|---|---|---|
| Formula | pH | Gravity¹ | Viscosity | Run 1² | Run 2² | Average |
| A | 10.89 | 1.05 | 116 | 3.28 | 3.25 | 3.27 |
| B | 10.65 | 1.03 | 18 | 3.09 | 3.09 | 3.09 |
| C | 10.63 | 1.02 | 665 | 1.01 | 0.98 | 1.0 |
| D | 10.72 | 1.03 | 1050 | 1.18 | 1.18 | 1.18 |
| E | 10.87 | 1.04 | 214 | 2.68 | 2.67 | 2.68 |
| F | 10.77 | 1.03 | 542 | 0.83 | 0.83 | 0.83 |
| G | 10.73 | 1.03 | 437 | 1.93 | 1.93 | 1.93 |
| H | 10.62 | 1.02 | 558 | 0.63 | 0.61 | 0.62 |
| I | 10.65 | 1.03 | 71 | 2.54 | 2.55 | 2.55 |
| J | 10.63 | 1.02 | 222 | 1.55 | 1.53 | 1.54 |
| (Comparative) | | | | | | |

¹A dimensionless quantity defined as the ratio of the density (mass divided by volume) of a substance (here, Formulas A-J) to the density of water, or Specific Gravity = ρ_{substance}/ρ_{water.}
²Tested at 10% formula dilution.

### Example 3

Based on the predictive variance of the ANOVA regression from the data in Example 2, additional exemplary detergent compositions (Formulations K-M) were prepared using the same base formulation in Table 1 and post dosed at the ratios as described in Table 5 to fill the 17.28% hole. Formulations K-M were designed to maintain viscosity between 75 to 1500 cP, keep dioxane to less than 1 ppm, result in a Zein score (tested at 10% formulation dilution) of less than 1.25% and have no more than 10 losses vs. Formulation J in win/loss performance.

TABLE 5

| | | | | | Zein Avg | Viscosity |
|---|---|---|---|---|---|---|
| Formula | NI | SLES | MGDA | Total | (%) | (cP) |
| J | 0.65 | 0.33 | 0.023 | 1 | 1.54 | 222 |
| (Comparative) | | | | | | |
| K | 0.75 | 0.23 | 0.019 | 1 | 1.21 | 319 |
| (25% Anionic | | | | | | |
| Reduction) | | | | | | |
| L | 0.82 | 0.17 | 0.011 | 1 | 0.86 | 308 |
| (50% Anionic | | | | | | |
| Reduction) | | | | | | |
| M | 0.91 | 0.08 | 0.007 | 1 | 0.66 | 482 |
| (75% Anionic | | | | | | |
| Reduction) | | | | | | |

NI: nonionic surfactant (alcohol ethoxylate, 25-7)
SLES: sodium lauryl ether sulfate, 3EO
MGDA: methylglycinediacetic acid

### Example 4—Additional Exemplary Formulations

Exemplary Formula 1 (wt/, based on the total weight of the sheet composition):
a) Inactive component—Polyvinyl alcohol: 1 to 50 wt %
b) Active component:
a. Non-aqueous Solvent: 0 to 15 wt % (PEG400, Glycerin, Propylene Glycol, etc.)
b. Anionic Surfactant: 0 to 5 wt % (such as LAS, SLES (which can have 1 to 5 degrees of ethoxylation)
c. Nonionic Surfactant: 1 to 30 wt % (such as alcohol ethoxylates e.g. C12-C15 with 7EO, but can have varying carbon chain lengths and degrees of ethoxylations)
d. Performance Enhancers: 0 to 15 wt % (Enzymes, polymers, builders, etc.)

Exemplary Formula 2 (wt/o, based on the total weight of the sheet composition):
a) Inactive component—Polyvinyl alcohol: 30 to 60 wt %
b) Active component:
a. Non-aqueous Solvent: 2 to 5 wt % (PEG400, Glycerin, Propylene Glycol, etc.)
b. Anionic Surfactant (LAS, SLES): 0 wt % LAS, 3-5 wt % SLES (3EO)
c. Nonionic Surfactant (25-7; C12-C15, 7EO): 1 to 30 wt %
d. Performance Enhancers: 1-2% Enzymes (such as protease, amylase, mannanase, lipase, and other enzymes described herein), 2-3% Polymer (PEIE, anti-redeposition polymers, soil release polymers and other known in the art), Chelant.

### Exemplary Formula 3

Package A: Sheet Matrix/Polymers/Builders
Package B: SLES/NI/MGDA ratios found in Examples 1, 2 and 3

Package A+B=Full Formula

The breadth and scope of the present invention should not be limited by any of the above-described exemplary embodiments but should be defined only in accordance with the following claims and their equivalents.

What is claimed is:

1. A mild detergent formulation comprising at least one inactive component and an active component incorporated into and/or onto the inactive component, wherein
the inactive component comprises a matrix or substrate material made of a non-active ingredient, and
the active component comprises:
an anionic surfactant;
a nonionic surfactant;
a chelating agent; and
one or more additives,
wherein the ratio of the nonionic surfactant, the anionic surfactant and the chelating agent ranges from about 70:1:0.001 to about 99:23:16.

2. The detergent formulation of claim 1, wherein the inactive component is water dissolvable.

3. The detergent formulation of claim 2, wherein the detergent formulation is in the form of a sheet.

4. The detergent formulation of claim 3, wherein the thickness of the sheet ranges from about 0.1 mm to about 20 mm.

5. The detergent formulation of claim 3, wherein the sheet has dimensions ranging from about 5×5 cm to about 40×40 cm.

6. The detergent formulation of claim 1, wherein the non-active ingredient comprises a polyvinyl, a cellulosic material, a starch, a paraffin, glycerin, propylene glycol, an α-olefin sulfonate, or any combination thereof.

7. The detergent formulation of claim 6, wherein the inactive component is in the form of a sheet.

8. The detergent formulation of claim 1, wherein the active component further comprises an aqueous solvent and/or a non-aqueous solvent.

9. The detergent formulation of claim 1, wherein the chelating agent comprises tetrasodium iminodisuccinate (IDS), ethylenediamine-N,N′-disuccinic acid (EDDS), methylglycinediacetic acid (MGDA), or any combination thereof.

10. The detergent formulation of claim 1, wherein the ratio of the nonionic surfactant, the anionic surfactant and the chelating agent ranges from about 78:1:0.001 to about 99:15:15.

11. The detergent formulation of claim 1, wherein the ratio of the nonionic surfactant, the anionic surfactant and the chelating agent ranges from about 89:1:0.001 to about 99:8:10.

12. The detergent formulation of claim 1, wherein the one or more additives are selected from the group consisting of acids, bases, amino acids, polymers, defoamers, chlorine scavengers, optical brighteners, fragrances, malodor control agents, enzymes, corrosion inhibitors, and any combination thereof.

13. The detergent formulation of claim 1, wherein the active component and the inactive component are a homogenous mixture.

14. The detergent formulation of claim 1, wherein the detergent formulation comprises from about 1 to about 95 wt % of the inactive component and from about 5 to about 99 wt % of the active component.

15. The detergent formulation of claim 1, wherein the detergent formulation comprises from about 30 to about 60 wt % of the inactive component and from about 40 to about 70 wt % of the active component.

16. The detergent formulation of claim 1, wherein the nonionic surfactant comprises an alcohol alkoxylate and the anionic surfactant comprises an alkyl ether sulfate of salt thereof.

17. The detergent formulation of claim 1, further comprising one or adjunct detergent ingredients.

18. The detergent formulation of claim 1, wherein
the detergent formulation is water soluble and dissolves within 0.1 to 60 seconds after water contact; and/or.
the detergent formulation has a density ranging from about 20 to about 500 g/m² and/or a weight ranging from about 0.1 to about 90 g.

19. The detergent formulation of claim 1, wherein the active component exhibits a zein score of less than about 1.5%.

20. The detergent formulation of claim 1, wherein the active component exhibits a zein score of less than about 1.0%.
